(19) United States
(12) Patent Application Publication
(10) Pub. No.: US 2006/0230057 A1
(43) Pub. Date: Oct. 12, 2006

(54) Method and apparatus for mapping web services definition language files to application specific business objects in an integrated application environment

(75) Inventors: Yury Kosov, San Francisco, CA (US); Thomas Pollinger, Cupertino, CA (US)

Correspondence Address: DUKE W. YEE, P.O. BOX 802333, YEE & ASSOCIATES, P.C., DALLAS, TX, 75380, US

(73) Assignee: International Business Machines Corporation, Armonk, NY (US)

(21) Appl. No.: 11/101,773

(22) Filed: Apr. 8, 2005

(51) Int. Cl. G06F 17/00

(52) U.S. Cl. 707/102

(57) ABSTRACT

A method, an apparatus, and computer instructions are provided for mapping Web services definition language (WSDL) files to application specific business objects. A WSDL reader parses WSDL files and builds a WSDL syntax tree. If a types section is present in the tree, a schema resolver generates a set of meta business objects (BOs) holding references to the schema. A BO ASI resolver registry identifies WSDL business object application specific information (BO ASI) builder. The WSDL BO ASI builder fills in ASI fields of meta BOs. The WSDL reader sends the tree and meta BOs to a WSDL resolver, which builds a set of WSDL configuration BOs and root WSDL BOs. A BO writer writes out the WSDL configuration BOs and root WSDL BOs. In business integration scenarios, a WSDL interface is provided to keep references to source artifacts between different artifacts to port the business integration scenario.

### CROSS-REFERENCE TO RELATED APPLICATIONS

The present invention is related to the following applications entitled Using Schemas to Generate Application Specific Business Objects for Use in an Integration Broker, Ser. No. ______ attorney docket no. SVL920040075US1 filed on ______.

### BACKGROUND OF THE INVENTION

1. Technical Field

The present invention relates to an improved network data processing system. In particular, the present invention relates to an integrated application environment in a network data processing system. Still more particular, the present invention relates to mapping Web services definition language files to application specific business objects in an integrated application environment.

2. Description of Related Art

In an integrated application environment, an integration server integrates different types of applications and shares business objects among these applications. An exemplary type of application is a Web Services Definition Language (WSDL) application. WSDL is a language definition used by Web services providers to publish available services or operations to users over the Internet. WSDL is an open source standard available from the World Wide Web Consortium (W3C). Most Web services are offered via standalone applications, as part of a larger business integration, or as an interface of available operations in the context of a business integration language.

Some of the Web services may use message protocols, such as simple object access protocol (SOAP), to encode their messages. Usually, message parameters are encoded as XML schemas, which describe the structure of message parameters in a markup language format. In addition, SOAP also includes additional types that facilitate other message components, such as arrays, sparse arrays, etc.

In the current integrated application environment, message parts of a Web service can be mapped to business objects, such that the Web service is enabled when the business objects representing the message parts are converted to or from SOAP envelopes. This functionality is available via the use of Web services adapters. Thus, the Web services adapter interprets application specific information (ASI) fields of the business objects in order to relate them to the correct WSDL parts.

In order to relate business objects to corresponding WSDL parts, three main approaches are currently used. The first approach is the use of Web services object discovery agents (WS-ODAs), which generate business objects and configures the ASI fields of the business objects, such that the business objects are understandable by the Web services adapter. This approach is mostly used in the context of a standalone Web services application.

The second approach is a highly manual integration process that is used in part in a larger business integration scenario. Even though WS-ODA can be used to generate a first set of business objects, relationships between different artifacts are lost as the business objects are used in a larger business context. Thus, business objects may not correlate to their WSDL parts. Examples of artifacts include extensible style sheet language transformation (XSLT) files.

A third approach is to separate the schema part of the WSDL definition section out and run the extensible markup language (XML) object discovery agent (ODA) to generate business objects. XML ODA generates business objects from XML documents. In cases where WSDL is used to describe an operation interface in the context of a business process, the ASI fields and configuration objects required by the Web services adapter are meaningless and may lead to confusion when trying to import the artifacts. As the SOAP binding part in the WSDL is missing, the Web services ODA does not generate business objects. Thus, all relationships between different business integration artifacts are lost and need to be manually created in business integration.

While the above approaches provide ways to relate WSDL parts to business objects that are understandable by the Web services adapter, these approaches fail to preserve relations between artifacts and requires significant efforts by the user.

Therefore, it would be advantageous to have an improved method for mapping WSDL files to application specific business objects, such that WSDL parts may be related to business objects in a large business integration context while preserving relationship between artifacts.

### SUMMARY OF THE INVENTION

The present invention provides a method, an apparatus, and computer instructions for mapping Web services definition language (WSDL) files to application specific business objects. A WSDL reader first detects a Web services definition language (WSDL) file and parses the WSDL file to generate a WSDL syntax tree. Responsive to determining that a types section is present using the WSDL syntax tree, a schema resolver is provided to generate a set of meta business objects (BOs) holding references to the schema for the types section. A business object application specific information (BO ASI) resolver registry then identifies a WSDL business object application specific information (BO ASI) builder that recognizes the schema format. The builder fills in application specific information (ASI) fields of the meta business objects. Subsequently, a WSDL resolver is provided to generate a set of WSDL configuration objects for the meta BOs and root WSDL BOs for message and parameter operations of the WSDL file. The identified WSDL BO ASI builder then fills in ASI fields of the configuration objects and root WSDL business objects, and calls a business object writer to write out the objects.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in accordance with an illustrative embodiment of the present invention;

FIG. 2 is a block diagram of a data processing system that may be implemented as a server in accordance with an illustrative embodiment of the present invention;

FIG. 3 is a block diagram illustrating a data processing system in accordance with an illustrative embodiment of the present invention;

FIG. 4 is a diagram illustrating an integrated application environment in accordance with an illustrative embodiment of the present invention;

FIG. 5 is a diagram illustrating a generic framework for reading markup language schemas to form business objects in accordance with an illustrative embodiment of the present invention;

FIG. 6 is a diagram illustrating a generic framework for reading WSDL files to generate WSDL business objects and configuration business objects with added WSDL reader, WSDL resolver, and WSDL BO ASI builder in accordance with an illustrative embodiment of the present invention;

FIG. 7A is a diagram illustrating an exemplary WSDL file used to build WSDL compliant business objects in accordance with an illustrative embodiment of the present invention;

FIG. 7B is a diagram illustrating an exemplary WSDL file used to build WSDL compliant business objects in continuation of FIG. 7A in accordance with an illustrative embodiment of the present invention;

FIG. 8 is a diagram illustrating an exemplary meta business object structure for WSDL file 700 in FIGS. 7A and 7B in accordance with an illustrative embodiment of the present invention;

FIG. 9A is a diagram illustrating details of WS_OrderBooks_OrderBookMsg 802 in FIG. 8 in accordance with a preferred embodiment of the present invention;

FIG. 9B is a diagram illustrating details of WS_OrderBooks_OrderBookMsg 802 in FIG. 8 in continuation of FIG. 9A in accordance with a preferred embodiment of the present invention;

FIG. 10 is a diagram illustrating an exemplary business integration scenario in accordance with an Illustrative embodiment of the present invention;

FIG. 11 is a diagram illustrating relationships of source artifacts, meta artifacts, and final business

integration artifacts for the exemplary business integration scenario illustrated in FIG. 10 in accordance with an illustrative embodiment of the present invention; and

FIG. 12 is a flowchart of an exemplary process for mapping WSDL files to WSDL business objects in accordance with an illustrative embodiment of the present invention.

### DETAILED DESCRIPTION OF THE PREFERRED EMBODIMENT

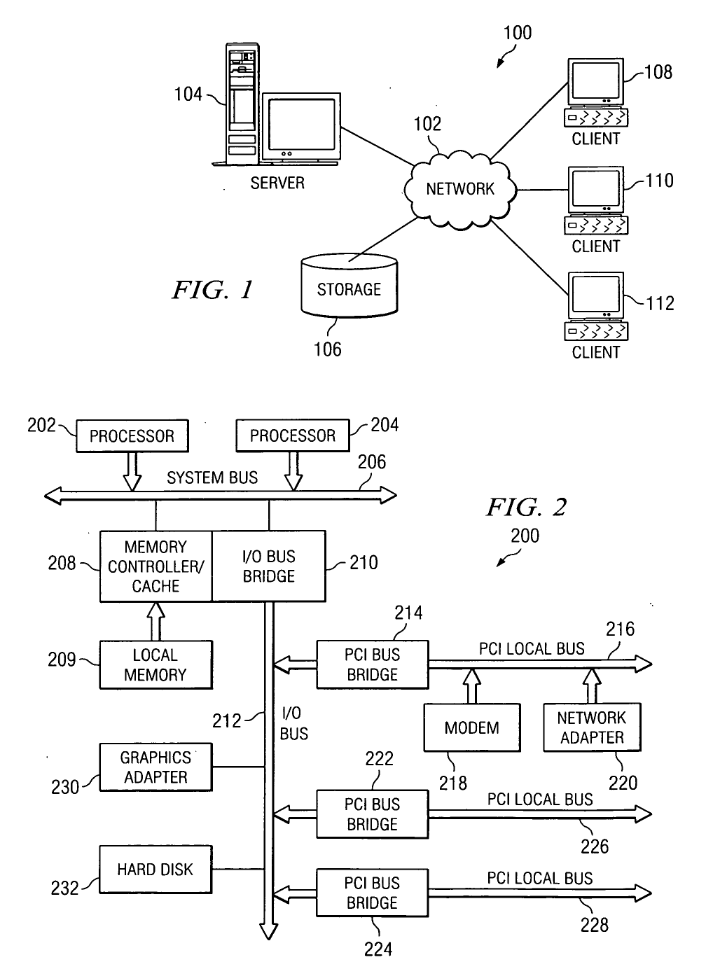

With reference now to the figures, FIG. 1 depicts a pictorial representation of a network of data processing systems in which the present invention may be implemented. Network data processing system 100 is a network of computers in which the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with an illustrative embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. Memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

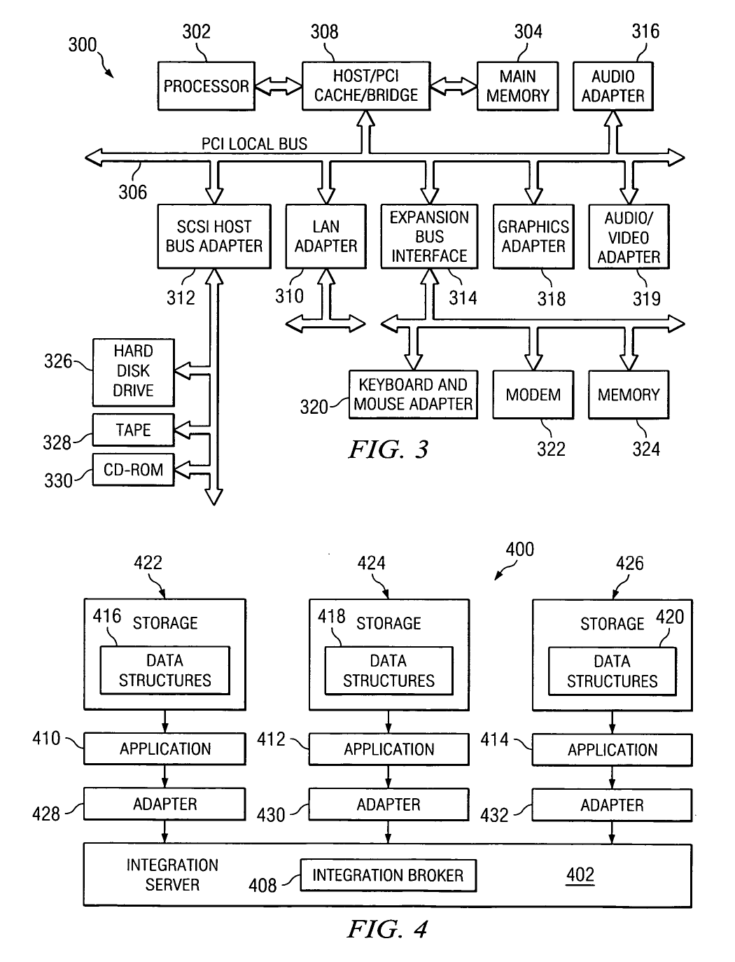

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object-oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand-held computer in addition to taking the form of a PDA. Data processing system 300 also may be a kiosk or a Web appliance.

As described in related patent application, entitled “Using Schemas to Generate Application Specific Business Objects for Use in an Integration Broker,” incorporated by reference above, when a source application wants to communicate with a destination application in an integrated application environment, adapters are used to transform data in the source format to the destination format. Specifically, an adapter of the source application may convert proprietary data or application specific business objects to generic business objects understood by the integrated environment. Business objects are containers that hold fields of any type.

Business object fields may include a field type, a field name, and a field ASI. Field name indicates the name of the field, such as street. Field type indicates the type of the field, for example, a string, an integer, or a long. Field ASI is typically empty if the business object is a generic business object or it may hold information for its matching application adapter. A user may also include comments for each field to indicate status, such as whether the field is a foreign key, a key, a default value, or whether the field may be null or not. An instance of the business object definition holds instance values that conform to the type defined in the business object definition.

Upon receiving the generic business objects, an adapter of the destination application may convert the generic business objects back to application specific business objects for the destination application. In this way, collaboration may be achieved between the source and destination applications, since adapters normalize their underlying application.

Turning now to FIG. 4, a diagram illustrating an integrated application environment is depicted in accordance with an illustrative embodiment of the present invention. As depicted in FIG. 4, integration application environment 400 includes integration server 402. Integration server 402 may be implemented as data processing system 200 in FIG. 2.

Integration server 402 includes integration broker 408, which provides services for transfer of data in application specific business objects among applications 410, 412, and 414. Applications 410, 412, and 414 are clients for integration broker 402 and maintain data in application specific data structures 416, 418, and 420 respectively. Application specific data structures 416, 418, and 420 may reside in vendor specific databases, such as storage 422, 424, and 426, or tied to an application that may not have storage attached.

When a source application, such as application 410, receives a new customer address, adapter 428 reads the customer with the new customer address and transforms it into an application specific business object. Adapter 428 then sends the application specific business object to integration broker 408. Integration broker 408 includes a map that maps the application specific business object into a generic business object, which represents relevant parts of the customer field in a normalized way.

The generic business object does not have any application specific information fields and is used in generic collaborations, while the application specific business object looks structurally the same as the generic business object, but with ASI fields initialized to work with adapter 428. Adapter 428 transforms application specific business objects to a format understood by application 410. Examples of formats include XML, database SQL queries, IDOC, BAPI for SAP, simple output text files or direct connection to a third-party vendor application programming interface.

A collaboration mechanism within integration broker 408 that provides synchronization between the source adapter and the target adapter accepts the generic business object, and sends an update request to target adapter 430 of target application 412.

Before returning the object to target adapter 430, Integration broker 408 maps the generic object into the target application specific business object. Once the application specific business object is received by target adapter 430, target adapter 430 sends the updated address information in the target application's format to target application 412.

While, in this illustrative embodiment, three adapters are provided to transfer data between data structures, any number of additional adapters may be provided to transfer data between additional data structures without departing the spirit and scope of the present invention. In addition, adapters may be implemented as a standalone adapter or tied to a target application that may not have a storage device attached. An example of a standalone adapter is a source adapter, which reads temperature from a measuring device. An example of an adapter tied to a target application is a front end that is tied to some other application.

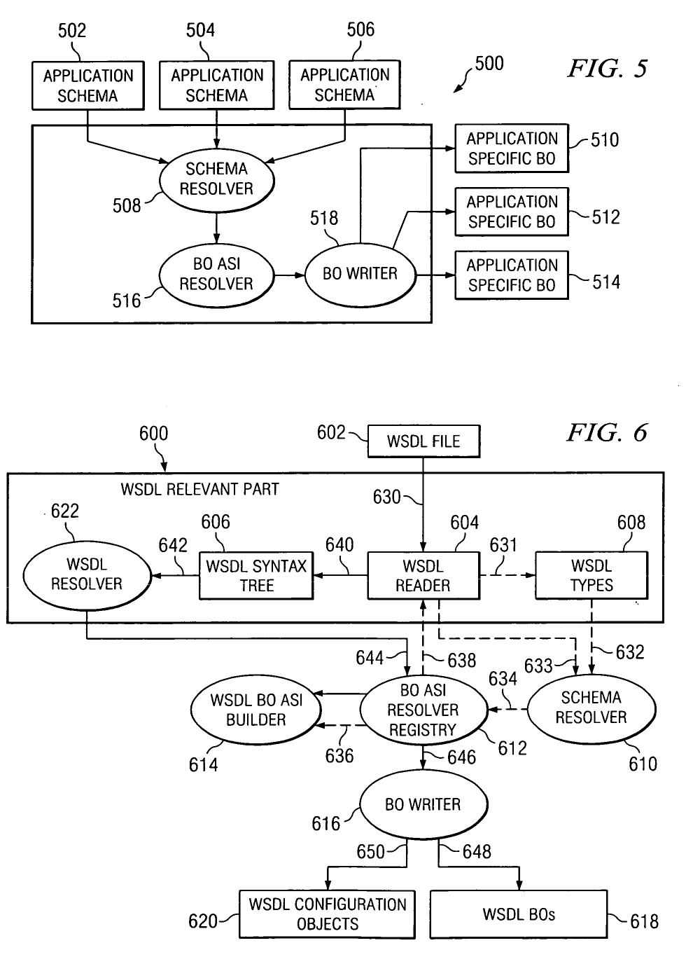

Turning now to FIG. 5, a diagram illustrating a generic framework for reading markup language schemas to form business objects is depicted in accordance with an illustrative embodiment of the present invention. As depicted in FIG. 5, in integration broker 500, application markup language schemas 502, 504, and 506 may be provided to define the structure and formats of application specific data structures, such as data structures 416, 418, and 420 in FIG. 4.

Schemas 502, 504, and 506 are parsed by schema resolver 508 to generate base structures for application specific business objects 510, 512, and 514. These base structures are known as meta business objects (BOs). Meta BOs hold information for the application specific business objects 510, 512, 514, as well as references to the original source schemas 502, 504, and 506. Schemas 502, 504, and 506 are then interpreted by business object ASI resolver 516 to populate application specific information (ASI) fields of the application specific business objects 510, 512, and 514. ASI fields provide information necessary to configure the target application. For example, in case of a target database application, ASI fields may include the database name, table names, and column names.

If BO ASI resolver 516 is able to populate the ASI fields, BO ASI resolver 516 populates the ASI fields and passes the application specific business objects 510, 512, and 514 to business object writer 518. BO writer writes out the business objects with ASI fields. BO ASI resolver 516 may also be extended to plug in additional specific ASI builders that are able to interpret a particular form of schema definition. More detail regarding the extension of BO ASI builder 516 is discussed in FIG. 6.

The present invention provides a method, an apparatus, and computer instructions for mapping WSDL files to application specific business objects in an integrated application environment. In an illustrative embodiment, the present invention extends the functionality of the business object application specific information (BO ASI) resolver to plug in a WSDL business object application specific information (BO ASI) builder for different WSDL scenarios. The WSDL BO ASI builder provides base functionality to support a variety of WSDL usage.

WSDL BO ASI builder fills in necessary application specific information (ASI) fields from a WSDL file and generates additional configuration objects that can be understood by the Web services adapter. WSDL BO ASI builder may import WSDL files from a WSDL URL or a parse tree. In addition, the WSDL BO ASI builder is easily embeddable as a utility application programming interface that generates Web services compliant business objects.

Unlike the prior art generated business objects, the generated meta business objects (BOs) hold references to the source schema definition in the WSDL type section. In addition, the meta BOs keep references to their matching WSDL messages and operations where the BOs are used. Thus, relationships between artifacts are preserved. In addition to meta BOs with references to their source schema section in WSDL file, the WSDL BO ASI builder helps relating generated BOs with their respective parts in the WSDL operations. This allows matching the BOs with their respective message parts of the parameters in the WSDL operations.

When a WSDL file or a collection of WSDL files is provided to a WSDL reader, the WSDL reader parses the WSDL file and generates a WSDL syntax tree. The WSDL syntax tree has a types section that defines composition types used in other parts of the WSDL sections and the types section is defined by means of a schema. The types section typically includes data type definitions that are relevant for the exchanged messages. The WSDL reader may accommodate different WSDL encodings, since the WSDL types may refer to these specific encodings. WSDL reader can augment the schema with definitions of these encodings.

In order to define the schema types, Simple Object Access Protocol (SOAP) extension types and mapping to equivalent meta business object constructs are plugged into a schema resolver if they have not already been. SOAP bindings extend the WSDL file to include a binding for SOAP 1.1 endpoints. However, other encoding extensions based on schema, such as SOAP 1.2, may also be supported by the schema resolver. SOAP and WSDL are open source standards available from World Wide Web Consortium (W3C).

After SOAP extensions types are plugged into the resolver, the WSDL reader sends WSDL syntax tree, which holds references to the enclosing WSDL tree, to the schema resolver. The schema resolver reads the WSDL syntax tree and generates meta business objects (BOs) with references to the source schema. The schema resolver has the capability to access namespace definitions available in the enclosing WSDL section. After meta business objects are generated, the schema resolver calls a BO ASI resolver registry. The BO ASI resolver registry includes a list of registered BO ASI builders that handle different types of schema definitions. In turn, a WSDL BO ASI builder recognizes the schema definition format, the enclosing WSDL structure, and possibly used SOAP extension elements.

The WSDL ODA ASI builder then fills the ASI fields of the meta BOs if necessary and constructs additional WSDL configuration objects that are needed by the Web services adapter. In this way, the Web services adapter may communicate with the appropriate Web service provider. After the ASI fields are filled, the meta business objects are sent back to the WSDL reader, which accepts the newly built meta business objects that can be used later for defining message parts.

After receiving the newly built meta business objects, the WSDL reader sends the WSDL syntax tree and the already defined meta business objects to a WSDL resolver. The WSDL resolver builds the meta business objects for WSDL configuration BOs and for the root BOs that are drawn from WSDL message and WSDL operation parameters. The WSDL resolver sends all meta business objects to the BO ASI resolver registry for finding a WSDL BO ASI builder to fill in ASI fields. After the ASI fields are filled, the meta business objects are sent to a BO writer, which writes out the WSDL business objects and configuration BOs.

Turning now to FIG. 6, a diagram illustrating a generic framework for reading WSDL files to generate WSDL business objects and configuration business objects with added WSDL reader, WSDL resolver, and WSDL BO ASI builder is depicted in accordance with an illustrative embodiment of the present invention. As depicted in FIG. 6, integration broker 600 is similar to integration broker 500 in FIG. 5, except that WSDL BO ASI builder 614 is added to communication with BO ASI resolver 616. In addition, WSDL reader 604 and WSDL resolver 622 are added to provide functionality for WSDL relevant parts.

When WSDL file 602 is received by WSDL reader 604 via link 630, WSDL reader 604 parses file 602 to generate WSDL syntax tree 606. WSDL reader 604 also examines the WSDL syntax tree 606 to determine if it has a types section 608 that defines composition types used in other parts of the WSDL sections by means of a schema. If types section 608 is present, WSDL reader 604 sends WSDL syntax tree 606 to schema resolver 610 via links 631 and 632. WSDL syntax tree 606 holds references to the enclosing WSDL tree.

In order to define the schema types section 608, SOAP extensions types and mapping to equivalent meta business object constructs are plugged into schema resolver 610 via link 633 if they have not already been. Schema resolver 610 reads WSDL syntax tree 606 and generates meta business objects (BOs) with references to the source schema. The schema resolver has the capability to access namespace definitions available in the enclosing WSDL section. Schema resolver 610 then sends the generated meta BOs to BO ASI resolver registry 612 via link 634, which keeps a list of available BO ASI builders that can handle different types of schema definitions.

From the list of BO ASI builders, BO ASI resolver registry 612 selects WSDL BO ASI builder 614 that recognizes the schema format, the enclosing WSDL structure, and possibly used SOAP extension elements. When WSDL BO ASI builder 614 is selected, BO ASI resolver registry 612 sends the meta BOs via link 636 to WSDL BO ASI builder 614, which fills the ASI fields of the business objects if necessary and constructs additional WSDL configuration business objects that are needed by the Web services adapter. The filled business objects are returned by BO ASI builder registry 612 to WSDL reader 604 via link 638. WSDL reader 614 then accepts the newly built meta business objects that can be used later for defining message parts.

After schema types section 608 are defined, WSDL reader 604 sends WSDL syntax tree 606 and defined schema types meta business objects to WSDL resolver 622 via link 640 and 642. WSDL resolver 622 builds meta business objects for the WSDL configuration business objects and for the root BOs that are drawn from WSDL messages and WSDL operation parameter types. WSDL configuration business objects represent other WSDL sections, such as bindings, messages, operations, ports, and services definitions.

Once WSDL resolver 622 builds the meta business objects, the objects are sent via link 644 to BO ASI resolver registry 612, which finds WSDL BO ASI builder 614 to fill in the ASI fields. Finally, the filled meta business objects are sent via link 646 to BO writer 616. BO writer 616 writes out the WSDL business objects 618 via link 648 for schema types and WSDL configuration business objects 620 via link 650 for other sections.

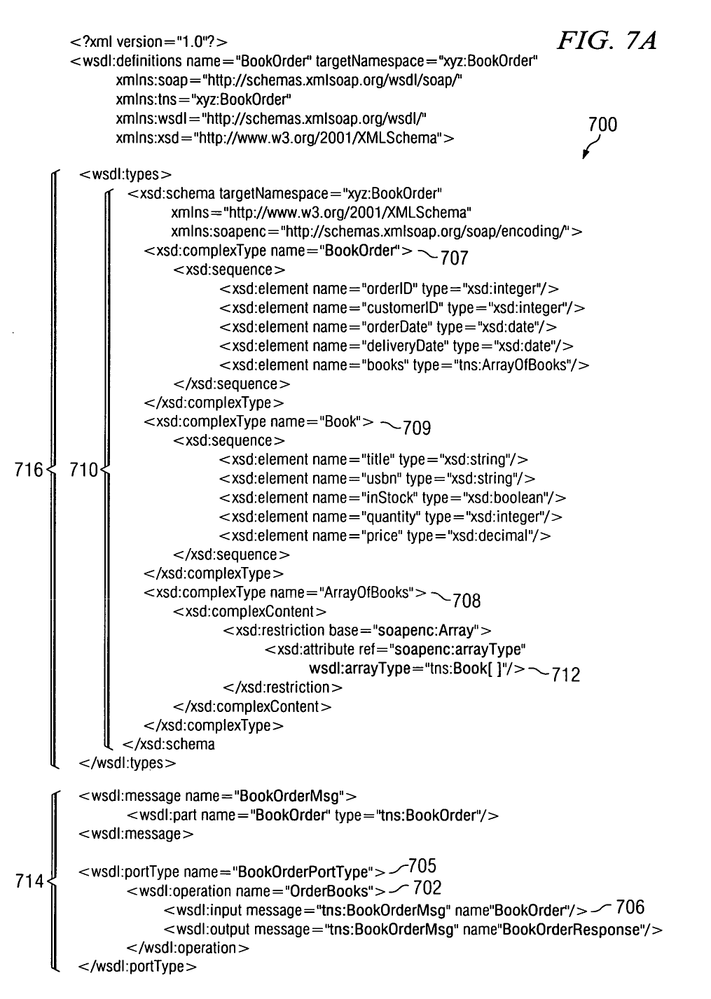

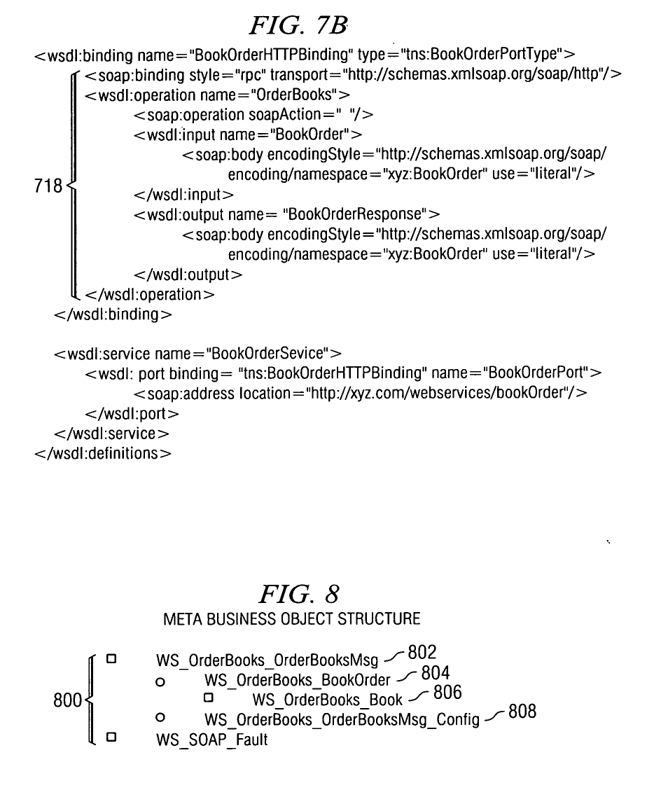

Turning now to FIG. 7A, a diagram illustrating an exemplary WSDL file used to build WSDL compliant business objects is depicted in accordance with an illustrative embodiment of the present invention. As depicted in FIG. 7A, WSDL file 700 is used to model a Web service that accepts book orders and returns the amount of books ordered and their price. Operation OrderBooks 702 in portType, BookOrderPortType 704, takes a BookOrderMsg 706 as an input and an output.

Part of BookOrderMsg 706 refers to a complex type, BookOrder 707, which is defined in schema section 710 of WSDL file 700. Schema section 710 is an embedded schema, but it has a SOAP encoding schema extension that models Book Array 712 as described in FIG. 7B. Book Array 712 includes a list of Books 709. In this illustrative example, portType and message section 714 is for configuration purposes and is handled by WSDL resolver, such as WSDL resolver 622 in FIG. 6, while type sections 716 is handled by schema resolver, such as schema resolver 610 in FIG. 6.

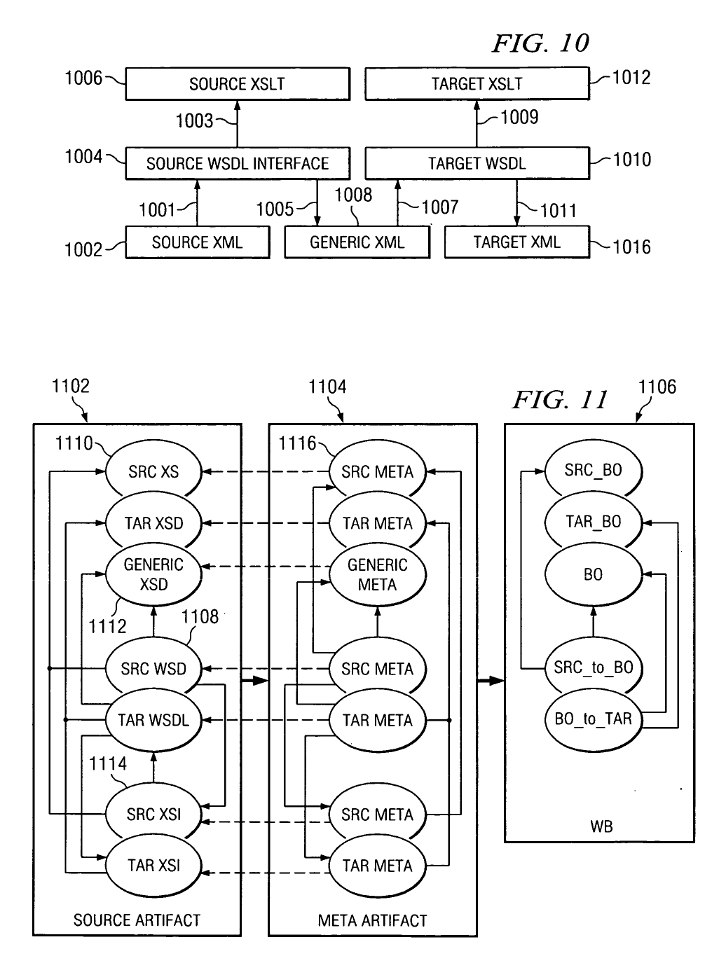

Turning now to FIG. 7B, a diagram illustrating an exemplary WSDL file used to build WSDL compliant business objects in continuation of FIG. 7A is depicted in accordance with an illustrative embodiment of the present invention. As depicted in FIG. 7B, in addition to types section 716, portType and message section 714, WSDL file 700 includes an optional SOAP binding section 718 that represents WSDL SOAP bindings for regular HTTP. Section 718 models Book Array 712 in FIG. 7A. If section 718 is missing, WSDL file 700 will define an interface in a large business integration process that is discussed in more detail in FIG. 10. In this case, the WSDL resolver is able to ignore this section and creates business objects that are used for that purpose.

Turning now to FIG. 8, a diagram illustrating an exemplary meta business object structure for WSDL file 700 in FIGS. 7A and 7B is depicted in accordance with an illustrative embodiment of the present invention. As shown in FIG. 8, meta business object 800 includes root object WS_OrderBooks_OrderBookMsg 802, which represents input/output OrderBookMsg 706 in FIG. 7A. Root WS_OrderBooks_OrderBookMsg 802 includes two child elements, WS_OrderBooks_BookOrder 804 and WS_OrderBooks_OrderBooksMsg_Config 808.

WS_OrderBooks_BookOrder 804 represents complex type BookOrder 707 in FIG. 7A, and it includes a child element, WS_OrderBooks_Book 806, which represents Book element 709 in FIG. 7A. WS_OrderBooks_OrderBooksMsg_Config 808 represents portType and message section 714 in FIG. 7A. In addition to WS_OrderBooks_BookOrder 804 root element, meta business object 800 includes WS_SOAP_fault element 810, which represents the SOAP binding extensions section 718 in FIG. 7B.

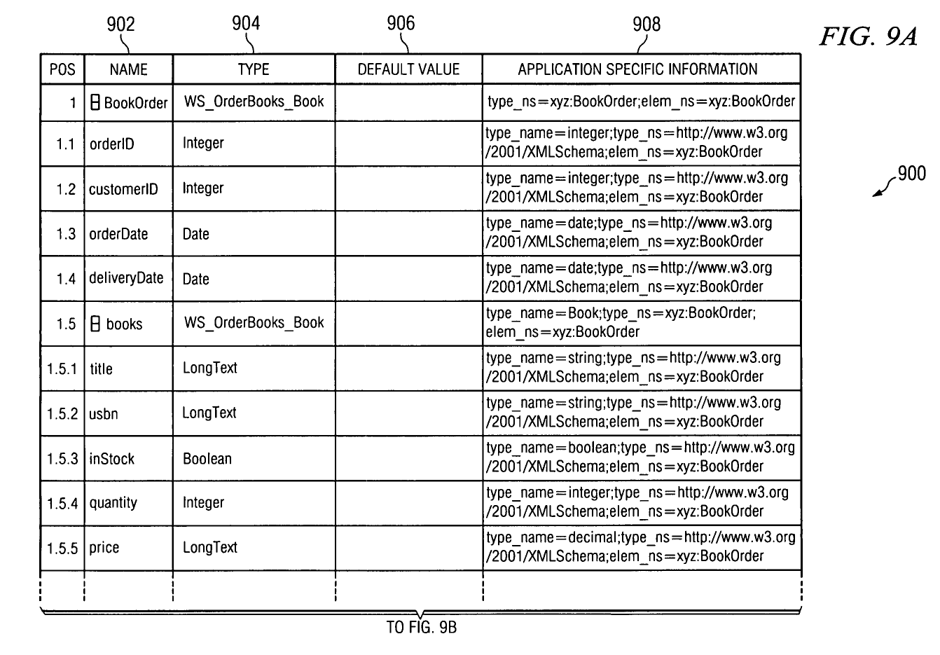

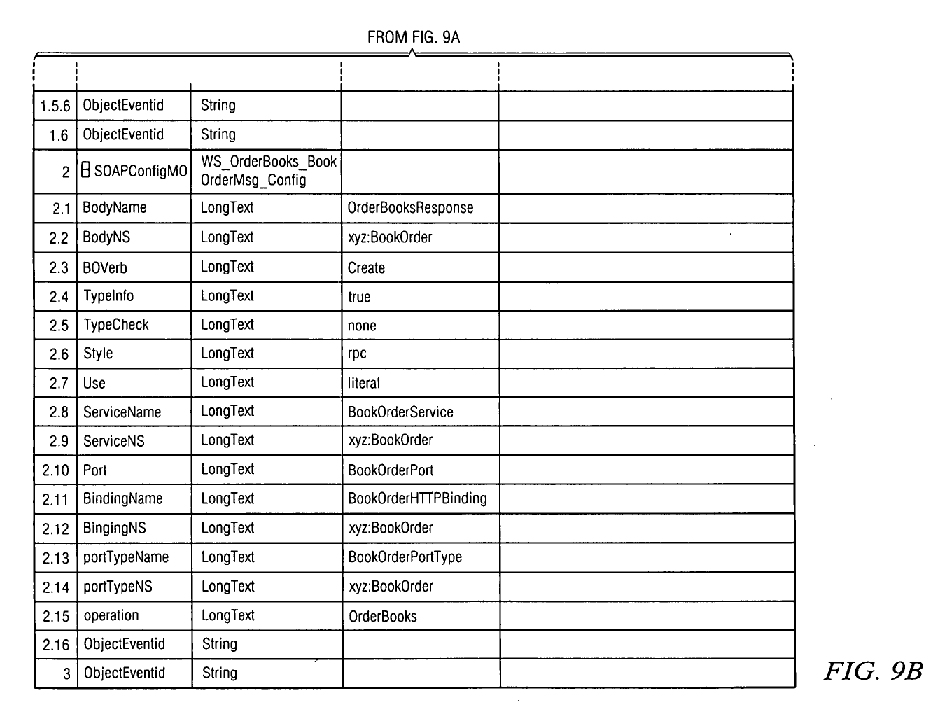

Turning now to FIG. 9A, a diagram illustrating details of WS_OrderBooks_OrderBookMsg 802 in FIG. 8 is depicted in accordance with a preferred embodiment of the present invention. As shown in FIG. 9A, hierarchy tree of WS_OrderBooks_OrderBookMsg business object 900 includes field names 902, field types 904, and default values 906 that are used in the configuration object for setting WSDL configuration parameters. The WSDL configuration parameters are set when a new configuration object is instantiated.

Turning now to FIG. 9B, a diagram illustrating details of WS_OrderBooks_OrderBookMsg 802 in FIG. 8 in continuation of FIG. 9A is depicted in accordance with a preferred embodiment of the present invention.

In addition to field names 902, types 904, and default values 906, WS_OrderBooks_OrderBookMsg business object 900 includes application specific information 908 that holds information regarding namespace of the corresponding field types and elements as they appear in the SOAP envelope instances. The elements are used by the Web services adapter to read and write SOAP envelopes.

In this example, WS_OrderBooks_OrderBookMsg business object 900 is a final business object that works in the business integration run time. The meta business object built by the WSDL reader and schema resolver hold additional references to WSDL source that may be partly lost in the final business objects.

Turning now to FIG. 10, a diagram illustrating an exemplary business integration scenario is depicted in accordance with an illustrative embodiment of the present invention. As shown in FIG. 10, in this exemplary scenario, amongst business object artifacts that typically map or transformation artifacts, such as XSLT, this scenario may involve collaboration artifacts and other possible artifacts.

In order to import these artifacts at run time, all references to the source of the business integration scenario are available in meta artifacts. Meta artifacts for maps, collaboration, and other possible artifacts are modeled similarly to the meta business objects. In their final business integration artifact form, they hold references to the original source.

In this illustrative example, a source business object is transformed into a target business object via an interface. In this scenario, the business integration language uses a schema to model business objects, WSDL file to model callable Web services, and XSLT to perform transformation or mapping on an XML instance that represent a business object. As mentioned above, if no SOAP bindings are present in the WSDL file, the WSDL may be used as an interface model.

For example, in this case, the source business object (BO) or source XML 1002 is sent to a map interface, such as source WSDL interface 1004, that transforms the source BO to a generic business object (link 1001). The source BO is then transformed in XSLT transformer 1006 to a generic BO (link 1003). In turn, the generic BO is sent back as output parameter of the WSDL interface (link 1005). Generic BO 1008 is then sent to the map or target WSDL interface 1010 that maps the generic BO to the target BO 1016 (link 1007). The target XSLT transformer 1012 then transforms the generic BO to target BO (link 1009). The target BO 1016 is then sent back as a result (link 1011).

Turning now to FIG. 11, a diagram illustrating relationships of source artifacts, meta artifacts, and final business integration artifacts for the exemplary business integration scenario illustrated in FIG. 10 is depicted in accordance with an illustrative embodiment of the present invention. As shown in FIG. 11, source artifacts 1102 model transformation business integration scenario as described in FIG. 10.

Meta artifacts 1104 and business integration runtime 1106 hold business integration artifacts that model the same business process. It is noted that while the business integration runtime 1106 artifacts do not have any corresponding WSDL artifacts as the calling interfaces are defined by respective artifacts and the extra indirection does not have to be modeled, meta artifacts 1104, however, have matching WSDL artifacts. Thus, the meta model is a superset of both the source and target platform.

In this example, source WSDL 1108 has a reference to source schema, source XSD 1110, and the generic schema, generic XSD 1112. Source XSD 1110 is the input parameter while generic XSD 1112 is the output respective result parameter, when calling the WSDL interface, source WSDL 1108, with the appropriate input parameter. Source XSD 1110 also has a reference to source XSLT 1114, which is the concrete transformation implementation for mapping source business object or source XML to target business object or target XML.

Source meta business object (BO) 1116 has a reference to source XSD 1110. This reference is broken down into fine grained reference for each field and child business object of the source business object in question. This reference to the source schema provides a pluggable configuration for the final business integration runtime artifacts 1106 and allows for addition of future source formats. The ease of integrating new formats help save programming efforts.

It is noted that the above example provides an illustrative embodiment of mapping of source artifacts to meta artifacts and to final business integration artifacts. While only a source and a target platform are illustrated, other types of platforms may be accommodated without departing the spirit and scope of the present invention.

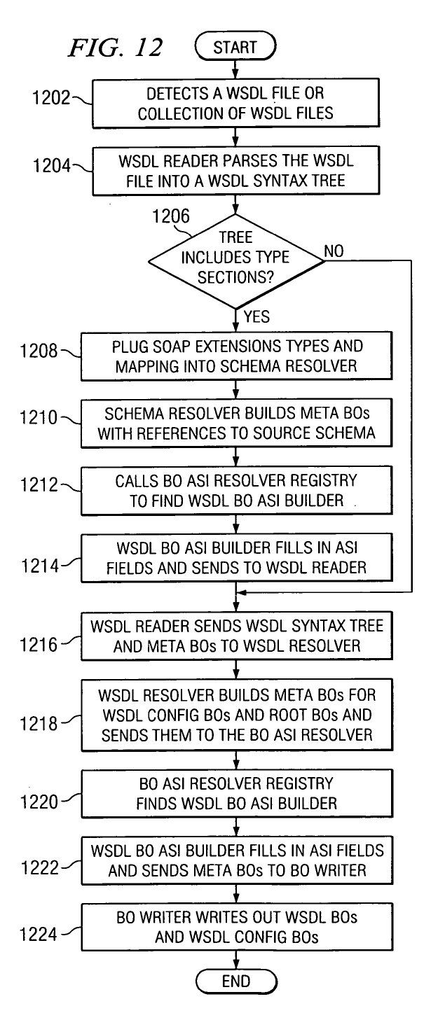

Turning now to FIG. 12, a flowchart of an exemplary process for mapping WSDL files to WSDL business objects is depicted in accordance with an illustrative embodiment of the present invention. As shown in FIG. 12, the process begins when a WSDL file or a collection of WSDL files are detected (step 1202). Next, the WSDL reader parses the WSDL file into a WSDL syntax tree (step 1204).

Next, a determination is made by the WSDL reader as to whether the WSDL syntax tree includes a types section (step 1206). If no types section is included, the process continues to step 1216. If a types section is included, the SOAP extension types and mapping are plugged into the schema resolver (step 1208). The schema resolver then builds meta business objects with references to the source schema (step 1210) and then calls the BO ASI resolver registry to find WSDL BO ASI builder (step 1212). Once the WSDL BO ASI builder is found, the builder fills in the ASI fields and sends the meta business objects back to the WSDL reader (step 1214).

At step 1216, the WSDL reader sends the WSDL syntax tree and meta business objects to the WSDL resolver. The resolver then builds target meta business objects for the WSDL configuration business objects and root business objects and sends the target meta business objects back to the BO ASI resolver registry (step 1218). The BO ASI resolver then finds the WSDL BO ASI builder (step 1220). The WSDL BO ASI builder then fills the ASI fields of the target meta business objects and sends the meta business objects to the BO writer (step 1222). The BO writer writes out the WSDL BOs and WSDL configuration BOs (step 1224) and the process terminates thereafter.

Thus, the present invention provides an improved method for mapping WSDL files to application specific business objects by extending the BO ASI resolver to plug in an additional WSDL BO ASI builder, which supports a variety of WSDL. With the WSDL BO ASI builder, schema types section of the WSDL may be related to the WSDL configuration objects while WSDL messages and WSDL operation parameter types may be related to WSDL business objects. In this way, WSDL parts may be related to business objects in a large business integration context while preserving relationships between artifacts.

In addition, if no SOAP bindings are present in the WSDL file, a WSDL interface is provided to map source artifacts to meta artifacts and then to final business integration artifacts.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal-bearing media actually used to carry out the distribution. Examples of computer readable media include recordable-type media, such as a floppy disc, a hard disk drive, a RAM, and CD-ROMs and transmission-type media, such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for mapping Web services definition language files to application specific business objects, the method comprising:
detecting a Web services definition language (WSDL) file;
responsive to detecting the WSDL file, parsing the WSDL file to generate a WSDL syntax tree, wherein the WSDL syntax tree comprises a set of types used in other sections of the WSDL file; and
determining if a types section of the WSDL file is present using the WSDL syntax tree, wherein the types section is defined in a schema format.

2. The method of claim 1, further comprising:
if the types section of the WSDL file is present, generating a set of meta business objects for the types section, wherein the set of meta business objects hold references to the schema;
identifying a WSDL business object application specific information builder from a plurality of business object application specific information builders, wherein the WSDL business object application specific information builder recognizes the schema format; and
filling in application specific information fields of the set of meta business objects using the WSDL business object application specific information builder.

3. The method of claim 2, further comprising:
generating a set of WSDL configuration objects for the set of meta business objects and a set of root WSDL business objects for message and parameter operations of the WSDL file;
filling in application specific information fields of the set of configuration objects and the set of root WSDL business objects; and
writing out the set of WSDL configuration objects and the set of root WSDL business objects.

4. The method of claim 1, wherein the WSDL file includes a collection of WSDL files, and a WSDL URL.

5. The method of claim 2, wherein the set of meta business objects include meta business objects for simple object access protocol extension section of the WSDL file.

6. The method of claim 1, wherein the detecting, parsing and determining steps are performed by a WSDL reader.

7. The method of claim 2, wherein the generating step is performed by a schema resolver, wherein the identifying step is performed by a business object application specific information resolver registry, and wherein the filling step is performed by the identified WSDL business object application specific information builder.

8. The method of claim 3, wherein the second generating step is performed by a WSDL resolver, the second filling step is performed an identified WSDL business object application specific information builder, and wherein the writing step is performed by a business object writer.

9. The method of claim 2, further comprising:
determining if a simple object access protocol extension section is present in the WSDL file;
if no simple object access protocol extension section is present in the WSDL file, transforming the set of meta business objects to a set of generic business objects using a source WSDL interface, wherein the transforming step comprises transforming the set of meta business objects in a extensible style sheet language transformer using a source extensible style sheet language file; and
sending the set of generic business objects to a target WSDL interface.

10. The method of claim 9, further comprising:
transforming the set of generic business objects to a set of target business objects using the target WSDL interface, wherein the transforming step comprises transforming the set of generic business objects in a extensible style sheet language transformer using a target extensible style sheet language file.

11. A data processing system comprising:
a bus;
a memory connected to the bus, wherein a set of instructions are located in the memory; and
a processor connected to the bus, wherein the processor executes the set of instructions to detect a Web services definition language (WSDL) file, parse the WSDL file to generate a WSDL syntax tree responsive to detecting the WSDL file, wherein the WSDL syntax tree comprises a set of types used in other sections of the WSDL file, and determine if a types section of the WSDL file is present using the WSDL syntax tree, wherein the types section is defined in a schema format.

12. The data processing system of claim 11, wherein the processor further executes the set of instructions to generate a set of meta business objects for the types section if the types section of the WSDL file is present, wherein the set of meta business objects hold references to the schema, identify a WSDL business object application specific information builder from a plurality of business object application specific information builders, wherein the WSDL business object application specific information builder recognizes the schema format, and fill in application specific information fields of the set of meta business objects using the WSDL business object application specific information builder.

13. The data processing system of claim 12, wherein the processor further executes the set of instructions to generate a set of WSDL configuration objects for the set of meta business objects and a set of root WSDL business objects for message and parameter operations of the WSDL file, fill in application specific information fields of the set of configuration objects and the set of root WSDL business objects, and write out the set of WSDL configuration objects and the set of root WSDL business objects.

14. The data processing system of claim 12, wherein the processor further executes the set of instructions to determine if a simple object access protocol extension section is present in the WSDL file, transform the set of meta business objects to a set of generic business objects using a source WSDL interface if no simple object access protocol extension section is present in the WSDL file, and send the set of generic business objects to a target WSDL interface, wherein the processor, in executing the set of instructions to transform the set of meta business objects to a set of generic business objects, transforms the set of meta business objects in an extensible style sheet transformer using a source extensible style sheet language file.

15. The data processing system of claim 14, wherein the processor further executes the set of instructions to transform the set of generic business objects to a set of target business objects using the target WSDL interface, wherein the processor, in executing the set of instructions to transform the set of generic business objects to a set of target business objects, transforms the set of generic business objects in an extensible style sheet language transformer using a target extensible style sheet language file.

16. A computer program product in a computer readable medium for mapping Web services definition language files to application specific business objects, the computer program product comprising:
first instructions for detecting a Web services definition language (WSDL) file;
second instructions for parsing the WSDL file to generate a WSDL syntax tree responsive to detecting a WSDL file, wherein the WSDL syntax tree comprises a set of types used in other sections of the WSDL file; and
third instructions for determining if a types section of the WSDL file is present using the WSDL syntax tree, wherein the types section is defined in a schema format.

17. The computer program product of claim 16, further comprising:
fourth instructions for generating a set of meta business objects for the types section if the types section of the WSDL file is present, wherein the set of meta business objects hold references to the schema;
fifth instructions for identifying a WSDL business object application specific information builder from a plurality of business object application specific information builders, wherein the WSDL business object application specific information builder recognizes the schema format; and
sixth instructions for filling in application specific information fields of the set of meta business objects using the WSDL business object application specific information builder.

18. The computer program product of claim 17, further comprising:
seventh instructions for generating a set of WSDL configuration objects for the set of meta business objects and a set of root WSDL business objects for message and parameter operations of the WSDL file;
eighth instructions for filling in application specific information fields of the set of configuration objects and the set of root WSDL business objects; and
ninth instruction for writing out the set of WSDL configuration objects and the set of root WSDL business objects.

19. The computer program product of claim 18, further comprising:
tenth instructions for determining if a simple object access protocol extension section is present in the WSDL file;
eleventh instructions for transforming the set of meta business objects to a set of generic business objects using a source WSDL interface if no simple object access protocol extension section is present in the WSDL file, wherein the eleventh instructions comprises instructions for transforming the set of meta business objects in a extensible style sheet language transformer using a source extensible style sheet language file; and
twelfth instructions for sending the set of generic business objects to a target WSDL interface.

20. The computer program product of claim 19, further comprising:
thirteenth instructions for transforming the set of generic business objects to a set of target business objects using a target WSDL interface, wherein the thirteenth instructions comprises instructions for transforming the set of generic business objects in a extensible style sheet language transformer using a target extensible style sheet language file.
